(19) United States
(12) Patent Application Publication
(10) Pub. No.: US 2025/0362978 A1
(43) Pub. Date: Nov. 27, 2025

(54) APPLICATION PROGRAMMING INTERFACE INVOCATION

(71) Applicant: SAP SE, Walldorf (DE)

(72) Inventors: Suchin Chouta, Udupi (IN); Shashank Mohan Jain, Karnataka (IN)

(21) Appl. No.: 18/672,943

(22) Filed: May 23, 2024

(51) Int. Cl. G06F 9/54; G06F 16/33

(52) U.S. Cl. CPC G06F 9/541; G06F 16/3347

(57) ABSTRACT

Methods, software, and systems for invoking application programming interfaces (APIs). A request to identify a sequence of APIs to perform a task is received. API data including textual characterization of multiple APIs is obtained, from a data collection engine. Vector representations are generated by embedding the API data of the APIs. The vector representations include a semantically searchable format. Relevant APIs ranking the APIs according to a similarity between the vector representations and the request are determined. A query for a completion engine is generated using the relevant APIs and the request. A set of APIs selected to perform the task is received. A recommendation including a structure of the sequence of APIs selected to perform the task is generated. The structure defines a calling order of the sequence of APIs. An application invoking, according to the calling order, the sequence of selected APIs is executed.

### TECHNICAL FIELD

The present disclosure relates to invoking application programming interfaces (APIs). More particularly, implementations of the present disclosure are directed to API invocation using Large Language Models (LLMs) as a tool.

### BACKGROUND

Libraries can offer a wide range of APIs that can provide various functions. Different versions of libraries can include changes or depreciations in their APIs that can be stored under multiple versions, each of the versions being compatible with a particular system type. Using APIs from libraries can introduce dependencies on other APIs and libraries. Relationships between APIs and libraries can affect the efficiency of the use of APIs while excessive API calls can impact performance of an application. In many cases, multiple API sequences can be identified for a procedure execution, but it might not be clear, which of the sequences is most efficient.

### SUMMARY

Implementations of the present disclosure are directed to techniques and tools for invoking application programming interfaces (APIs). More particularly, implementations of the present disclosure are directed to API invocation using Large Language Models (LLMs) as a tool.

In some implementations, a method includes: receiving a request to identify a sequence of application programming interfaces (APIs) to perform a task; obtaining, from a data collection engine, API data including textual characterization of a plurality of APIs; generating vector representations by embedding the API data of the plurality of APIs, the vector representations including a semantically searchable format; determining, by using a retrieval-augmented generation engine, relevant APIs ranking the plurality of APIs according to a similarity between the vector representations and the request; generating a query for a completion engine using the relevant APIs and the request; receiving, from the completion engine, a set of APIs selected to perform the task; generating, a recommendation including a structure of the sequence of APIs selected to perform the task, the structure defining a calling order of the sequence of APIs; and executing, using the structure, an application invoking the sequence of APIs selected according to the calling order of the sequence of APIs.

The foregoing and other implementations can each optionally include one or more of the following features, alone or in combination. In particular, implementations can include all of the following features:

In a first aspect, combinable with any of the previous aspects, the completion engine includes a trained large language engine. In another aspect, combinable with any of the previous aspects, the trained large language engine is trained using a plurality of tasks mapped to API sequence settings. In another aspect, combinable with any of the previous aspects, the API sequence settings define workflow conditions for a plurality of API types. In another aspect, combinable with any of the previous aspects, the API data includes metadata and specifications. In another aspect, combinable with any of the previous aspects, executing the application includes retrieving one or more APIs in the sequence of APIs from a database. In another aspect, combinable with any of the previous aspects, executing the application includes generating a new API to be included in the sequence of APIs. In another aspect, combinable with any of the previous aspects, executing the application includes generating an artifact matching the sequence of APIs.

In an aspect, combinable with any of the previous aspects, the prediction model includes a trained large language model. In another aspect, combinable with any of the previous aspects, the trained large language model is trained using a plurality of tasks mapped to API sequence settings. In another aspect, combinable with any of the previous aspects, the API sequence settings define workflow conditions for a plurality of API types. In another aspect, combinable with any of the previous aspects, the API data includes metadata and specifications. In another aspect, combinable with any of the previous aspects, the ranking engine includes a retrieval-augmented generation engine. In another aspect, combinable with any of the previous aspects, the embedding engine executes an embedding function to generate the vector representations of the API descriptions. In another aspect, combinable with any of the previous aspects, the graph recommendation engine includes a directed acyclic graph recommendation engine.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system that includes an embedding engine that receives, from a data collection engine, application programming interface (API) data of a plurality of APIs and generates vector representations by embedding the API data, wherein the API data includes textual characterization of a plurality of APIs and the vector representations include a semantically searchable format; a ranking engine that receives, from the embedding engine, the vector representations and generates a query using relevant APIs and a received request to identify a sequence of application programming interfaces (APIs) to perform a task, wherein the relevant APIs are determined by ranking the plurality of APIs according to a similarity between the vector representations and a request; a completion engine that determines a set of APIs selected to perform the task by using the query generated by the ranking engine; and a graph recommendation engine that processes the set of APIs to generate a structure recommendation.

These and other implementations can each optionally include one or more of the following advantages. The described implementation provides an efficient API discovery. The system streamlines the API discovery process by collecting and categorizing diverse APIs, enabling efficient exploration and evaluation of the available options without an overwhelming complexity. The described implementation provides an enhanced system productivity. By automating the sequence of API calls and generating tailored artifacts, the system enhances productivity, saving valuable time and effort in crafting and executing API workflows with various types of APIs, which minimizes usage of system resources and eliminates API incompatibility. The described enhanced implementations facilitate using a user-friendly interface for API discovery, intelligent recommendations, and a seamless process for invoking APIs.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for invocation of application programming interfaces (APIs), according to some implementations of the present disclosure.

FIG. 2 is a block diagram of an example API invocation system architecture, according to some implementations of the present disclosure.

FIG. 3A is a block diagram of an example API composition flow, according to some implementations of the present disclosure.

FIG. 3B is a block diagram of another example API composition flow, according to some implementations of the present disclosure.

FIG. 4 is a flowchart of an example process for API invocation, according to some implementations of the present disclosure.

FIG. 5 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to invoking application programming interfaces (APIs). More particularly, implementations of the present disclosure are directed to API invocation using Large Language Models (LLMs) as a tool. APIs can include, for example, programming interfaces (including events) that serve as the building blocks to support extensions and integrations from a computer application in a third-party system or language. APIs can interact with each other and with external systems enabling seamless integration with multiple platforms and services. Existing conventional approaches regarding API invocation can rely on, for example, a) documentation b) custom API catalogs (for example, SAP's GATEWAY CATALOG SERVICE), and c) hypermedia APIs such as Open Data Protocol (OData). Moreover, conventional approaches may not include sequencing optimization and integrations in a heterogenous landscape. Additionally, some tools might not include standard provisions of API descriptions, relating instead, to external identifiers and other protocols to fetch API information.

Addressing the limitations of traditional protocols of invoking APIs, the LLM based protocol described in the present disclosure enables automatic API invocation and optimization of API sequences. According to the described approach, LLMs are configured to determine a set of APIs to perform tasks. For example, the utility of LLMs is enhanced to seamlessly integrate with external systems and services through API interactions. The described solution overcomes potential challenges in optimizing LLMs for practical, task-oriented functions while ensuring efficient and contextually relevant API invocations. The approach broadens the scope of LLM applications by advantageously addressing considerations regarding optimization, accuracy, and adaptability in handling diverse external functionalities of APIs. As another advantage, the described LLMs address the balance between creative text generation and purposeful task execution using LLMs for identification and optimization of API sequences.

In some implementations, discovery of APIs and related connection information can be performed automatically by LLM-driven processes, based on the provided standardized descriptions. For example, automated processes can process the API descriptions to determine relationships (mapping) between APIs and connection information to optimize usage of system resources during implementation of generated API sequences. In some implementations, API providers can provide or publish information about their APIs for inclusion in the API catalog. LLM-readable formats can include, for example, JSON. In some implementations, the API catalog can be implemented as a centralized hub. The centralized hub can allow identification of relevant APIs that may have various (including proprietary) communication protocols. In some implementations, the API catalog can provide aggregated information that can be converted to API embeddings that are processable for ranking relevant APIs. LLMs can be trained to process the languages of the invocable APIs and to identify a set of applicable APIs that can be used to determine an order, in which the APIs can be optimally called as a sequence.

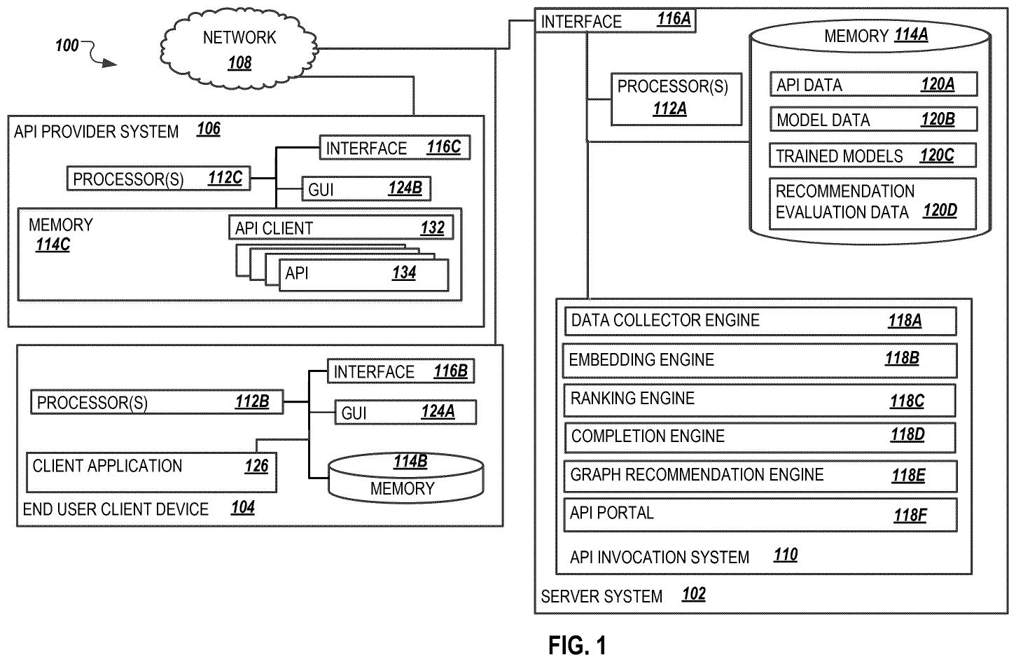

FIG. 1 is a block diagram of an example system 100 for invocation of APIs, according to some implementations of the present disclosure. Specifically, the illustrated example system 100 includes or is communicably coupled with a server system 102, an end-user client device 104, an API provider system 106, and a network 108. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool. In general, server systems 102 accept requests for application services and provides such services to any number of end-user client devices 104 (e.g., the client device 104 over the network 108). In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes. For example, the server system 102 includes an API invocation system 110, a processor 112A, a memory 114A, and an interface 116A.

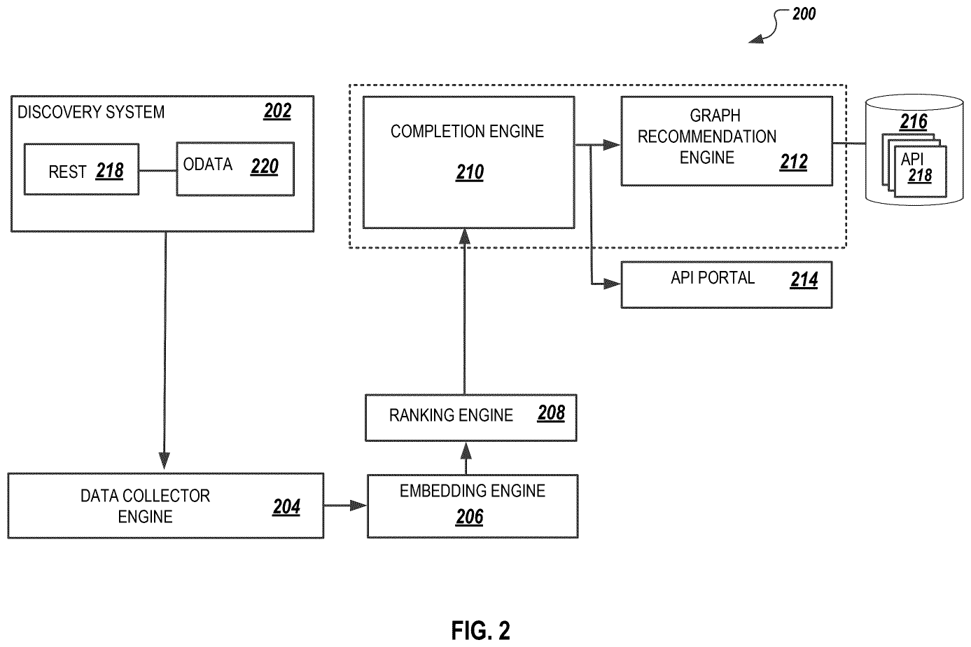

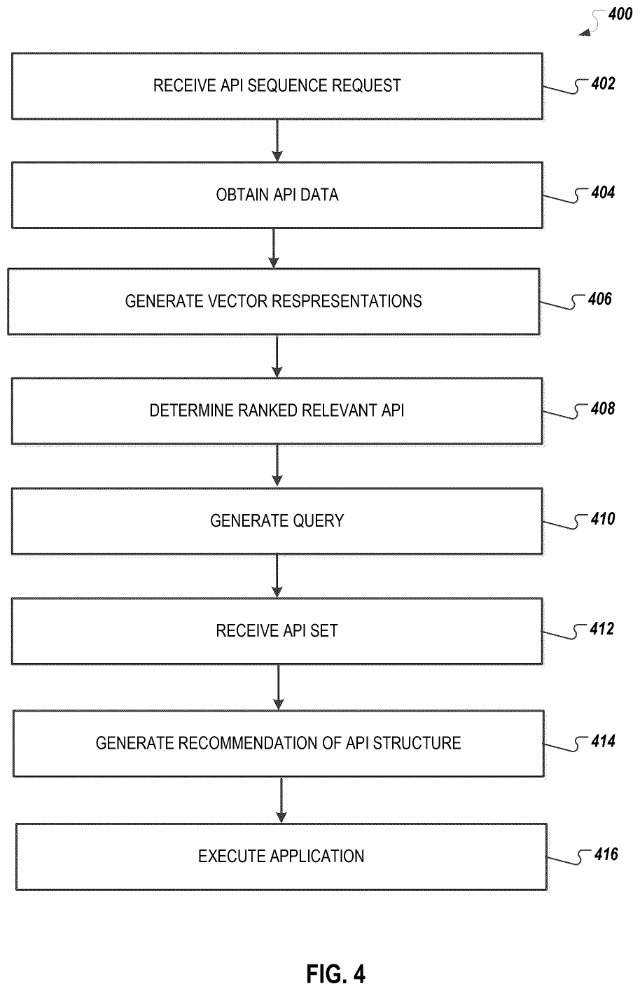

The API invocation system 110 can include a data collection engine 118A, an embedding engine 118B, a ranking engine 118C, a completion engine 118D, a graph recommendation engine 118E, and an API portal 118F. As end user client devices 104 generate requests for a sequence of APIs, the API invocation system 110 can be used to generate and call an optimized API sequence as described with reference to FIGS. 2 and 4. The ranking engine 118C, the completion engine 118D, and/or the graph recommendation engine 118E provide machine learning functionality for optimizing invocation of APIs.

The memory 114A can include API data 120A, engine data 120B, trained engines 120C, and recommendation evaluation data 120D. The API data (e.g., metadata) 120A can include a description of API input, API output, API dependencies, and mapping. The API data 120A can include documents defining aspects that point to APIs of API provider system(s) 106. API data 120A can provide references to external resources, which can be described by the integration target via open resource discovery (ORD). In some implementations, a dependency defined by API mapping can also point to resources within a same system (e.g., if the resource is to be used by the integration target as an information backchannel and/or if it defines the contract for the integration target. The API invocation system 110 can build and train engine(s) 120C, based on the engine data 120B, to generate trained engines 120C.

The end-user client device 104 and the API provider system 106 may each be any computing device operable to connect to or communicate in the network(s) 108 using a wireline or wireless connection. In general, each of the end-user client device 104 and the API provider system 106 includes an electronic computer device operable to receive, transmit, process, and store any appropriate data associated with the system 100 of FIG. 1. Each of the end-user client device 104 and the API provider system 106 is generally intended to encompass any client computing device such as a laptop/notebook computer, wireless data port, smart phone, personal data assistant (PDA), tablet computing device, one or more processors within these devices, or any other suitable processing device. The client device 104 and the API provider system 106 respectively include interface(s) 116B and 116C, processor(s) 112B and 112C, memories 114B and 114C, and graphical user interface(s) (GUIs) 124A and 124B. The end-user client device 104 can include one or more client applications 126. The client application 126 can be any type of application that allows a client device to request and view content on the client device (e.g., generate a request for synchronized customer data). In some implementations, a client application 126 can use parameters, metadata, and other API and event dependency information received at launch to access API invocation system 110 from the server system 102. In some instances, a client application 126 can be an agent or client-side version of the one or more enterprise applications running on an enterprise server (not shown). The memory 114C of the target API provider system 106 can include an API client 132, and APIs 134 that can be used for invoking API sequences.

In some implementations, any or all of the components of the example system 100, both hardware or software (or a combination of hardware and software), may interface with each other or the interface(s) 116A, 116B, and 116C (or a combination of both) over the network 108 for using a sequence of APIs 134. The APIs 134 may include specifications for routines, data structures, and object classes. The APIs 134 can be either computer-language independent or dependent and refer to a complete interface, a single function, or even a set of APIs 134 that are called, by the API invocation system 110, for providing software services to the end-user client device 104 or other components (whether or not illustrated) that are communicably coupled to the end-user client device 104. The functionality of the end-user client device 104 can be accessible for all service consumers using the client application 126 that transmits prompts to the API invocation system 110 to generate API sequences using relevant APIs 134.

For example, the end-user client device 104 and/or the API provider system 106 may comprise a computer that includes an input device, such as a keypad, touch screen, or other device that can accept user information, and an output device that conveys information associated with the operation of the server system 102, or the client device itself, including digital data, visual information, or a GUI 124A, 124B, respectively. The GUI 124A, 124B each interface with at least a portion of the system 100 for any suitable purpose, including generating a visual representation of the client application 126 or the administrative application 133, respectively. In particular, the GUIs 124A, 124B may each be used to view and navigate various Web pages. The GUIs 124A, 124B each provide the user with an efficient and user-friendly presentation of business data provided by or communicated within the system. The GUIs 124A, 124B may each comprise a plurality of customizable frames or views having interactive fields, pull-down lists, and buttons operated by the user. The GUIs 124A, 124B each contemplate any suitable graphical user interface, such as a combination of a generic web browser, intelligent engine, and command line interface (CLI) that processes information and efficiently presents the results to the user visually.

In some implementations, the network 108 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 108, is transferred using any number of network layer protocols, such as Internet Protocol (IP), Multiprotocol Label Switching (MPLS), Asynchronous Transfer Mode (ATM), Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 112A, 112B, 112C included in the end-user client device 104 or the API provider system 106 can be a central processing unit (CPU), an application specific integrated circuit (ASIC), a field-programmable gate array (FPGA), or another suitable component. Each processor 112A, 112B, 112C included in the end-user client device 104 or the API provider system 106 executes instructions and manipulates data to perform the operations of the end-user client device 104 or the API provider system 106, respectively. Specifically, each processor 112A, 112B, 112C included in the end-user client device 104 or the API provider system 106 executes the functionality required to send requests to the server system 102 and to receive and process responses from the server system 102. Each processor 112A, 112B, 112C can be a CPU, a blade, an ASIC, a FPGA, or another suitable component. Each processor 112A, 112B, 112C executes instructions and manipulates data to perform the operations of the respective system (the server system 102, the end-user client device 104, and the API provider system 106). Specifically, each processor 112A, 112B, 112C executes the functionality required to receive and respond to requests from the respective system (the server system 102, the end-user client device 104, and the API provider system 106), for example.

Interfaces 116A, 116B, 116C are used by the server system 102, the end-user client device 104, and the API provider system 106, respectively, for communicating with other systems in a distributed environment-including within the system 100—connected to the network 108. Generally, the interfaces 116A, 116B, 116C each comprise logic encoded in software and/or hardware in a suitable combination and operable to communicate with the network 108. More specifically, the interfaces 116A, 116B, 116C may each comprise software supporting one or more communication protocols associated with communications such that the network 108 or interface's hardware is operable to communicate physical signals within and outside of the illustrated system 100.

The memory 114A, 114B, 114C may include any type of memory or database module and may take the form of volatile and/or non-volatile memory including, without limitation, magnetic media, optical media, random access memory (RAM), read-only memory (ROM), removable media, or any other suitable local or remote memory component. The memory 114A, 114B, 114C may store various objects or data, including caches, classes, methodologies, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, the end-user client device 104, or the API provider system 106, respectively.

There can be any number of end-user client devices 104 and API provider systems 106 associated with, or external to, the system 100. Additionally, there may also be one or more additional client devices external to the illustrated portion of system 100 that are capable of interacting with the system 100 via the network(s) 108. Further, the term “client,” “client device,” and “user” can be used interchangeably as appropriate without departing from the scope of the disclosure. Moreover, while client device can be described in terms of being used by a single user, the disclosure contemplates that many users may use one computer, or that one user may use multiple computers. As used in the present disclosure, the term “computer” is intended to encompass any suitable processing device. For example, although FIG. 1 illustrates a single server system 102, a single end-user client device 104, a single API provider system 106, the system 100 can be implemented using a single, stand-alone computing device, two or more servers 102, or multiple client devices. The server system 102, the end-user client device 104 and the API provider system 106 may include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the end-user client device 104 and the API provider system 106 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 may also include or be communicably coupled with an e-mail server, a Web server, a caching server, a streaming data server, and/or another suitable server.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP (Advanced Business Application Programming), ABAP OO (Object Oriented), any suitable version of 4GL, as well as others. While portions of the software illustrated in FIG. 1 are shown as individual modules that implement the various features and functionality through various objects, methods, or other processes, the software may instead include multiple sub-modules, third-party services, components, libraries, and such, as appropriate. Conversely, the features and functionality of various components can be combined into single components as appropriate.

In some implementations, the API provider systems 106 can expose multiple relevant APIs in advance, with each of the APIs having a particular language (different from other API languages) and a particular communication protocol (different from other API communication protocols). The end user client device 104 can include various API consumption tools, for example, API management tools, visual studio (VS) and IOS (operating system) software development kits (SDKs), build tools, and web integrated development environment (WebIDE) tools. The communication between the end user client device 104 (as API consumers) and the API provider systems 110 can include several different communication protocols configured to optimized API invocation, as further described in detail with reference to FIGS. 2-5.

FIG. 2 illustrates a block diagram of an example API invocation system architecture 200, according to some implementations of the present disclosure. The example API invocation system architecture 200 (e.g., API invocation system 110, described with reference to FIG. 1) includes a discovery system 202, a data collection engine 204, an embedding engine 206, a ranking engine 208, a completion engine 210, a graph recommendation engine 212, an API portal 214, and an API memory 216.

The discovery system 202 includes a RESTful (REST) discovery engine 218 and an OData discovery engine 220. The data collection engine 204 receives API requests and collects information about available APIs included in or accessible by the discovery system 202 along with their respective metadata and specifications (e.g., Swagger and EDMX). The data collection engine 204 can collect information about available APIs based on API metadata. The data collection engine 204 can retrieve different types of API artifacts and transmit the collect API information to the embedding engine 206.

The embedding engine 206 can execute an embedding function (e.g., Python code) to create API embeddings (e.g., mathematical representations of API descriptions including metadata) for the APIs received from the data collection engine 204. Embedding includes creating vector representations for enabling semantic search on the collected APIs received from the data collection engine 204. The embedding engine 206 can transmit the embedded APIs to the ranking engine 208.

The ranking engine 208 is dedicated to evaluating and ranking API embeddings based on a particular query. The ranking engine 208 utilizes retrieval-augmented generation (RAG) engine for retrieval of augmented generation of a prompt. The RAG engine is an AI methodology for improving the quality of LLM-generated responses by grounding the engine on external sources of knowledge to supplement the LLM's internal representation of information. The ranking engine 208 can rank the extracted APIs from the vector store and transmit the ranking as a prompt to the completion engine 210.

The completion engine 210 can include an AI engine, such as an LLM system (e.g., GPT4, CLAUDE, Nous Hermes engine or any OSS like Mistral) configured to process the prompt (e.g., API request), relative to the set of ranked APIs embeddings, for identifying APIs for graph recommendations defining a set of APIs selected to perform the task. In particular, the prompts can be one or more of a question, statement, image, audio clip, etc. input by the user as a request to the virtual assistant. In particular, the prompt can be provided as an input to the completion engine 210 as a text “grant employee rights to access application” with corresponding API embeddings relevant for new employees and application access to generate graph recommendations as output. The completion engine 210 can be a trained engine including adjusted weights to learn graph recommendations, e.g., based on API relationships dependencies compatibilities and application fields.

The completion engine 210 can include or can be communicatively coupled to the graph recommendation engine 212. The graph recommendation engine 212 can include a directed acyclic graph (DAG) recommendation engine. The graph recommendation engine 212 uses the information from the set of APIs to generate a structure recommendation, such as graph (DAG) recommendations. The graph recommendation engine 212 can suggest sequences of API calls for efficient flows responsive to the requested application. The graph recommendation engine 212 transmit the sequences of API calls to the API portal 214. The API portal 214 can execute an API calling function to call the APIs 218 from the API memory 216 according to a particular identified sequence. The API calling function can include schemas, such as a JSON Schema or an XML Schema. The schemas can provide a description of serialized data that is part of API instances. In API sequences, an API is called in an order relative to one or more secondary APIs based on integration dependencies.

The example API invocation system architecture 200 includes an innovative API recommendation system that employs a robust data collection engine 204 to gather diverse APIs from the discovery system 202, an efficient embedding engine 206 for reducing the search space, to reduce the search from the data provided by the discovery system 202 to a relevant portion of the data. The example API invocation system architecture 200 feeds the relevant portion of the data (as embeddings) to the LLM to compose the set of APIs, generating a seamless integration, a dynamic RAG mechanism for prioritization, and a DAG Recommendation Component to generate optimal API sequences. The example API invocation system architecture 200 can be further optimized by efficient training of the adjusted weights of the completion engine. Large language engines can have billions or trillions of weights to update each training iteration. By relying on finetuning the weights of a pretrained base language processing network to generate the graph recommendations, the system can drastically reduce the computational resources required to train the adjusted weights. In particular, the system can use a low-rank approximation, or prompt tuning, to generate the adjusted weights for the completion engines. The example API invocation system architecture 200 provide API sequences orchestrated by the API portal 214 for streamlined execution and artifact generation. The example API invocation system architecture 200 ensures comprehensive coverage, adaptability, and efficiency in API utilization. The example API invocation system architecture 200 integrate an RAG mechanism with an LLM-based question answering system. The RAG-LLM integration provides two main benefits: 1) it ensures that the engine has access to the most current, reliable facts, and 2) it facilitates access to the engine's sources, ensuring that API sequences can be checked for accuracy and can be ultimately trusted.

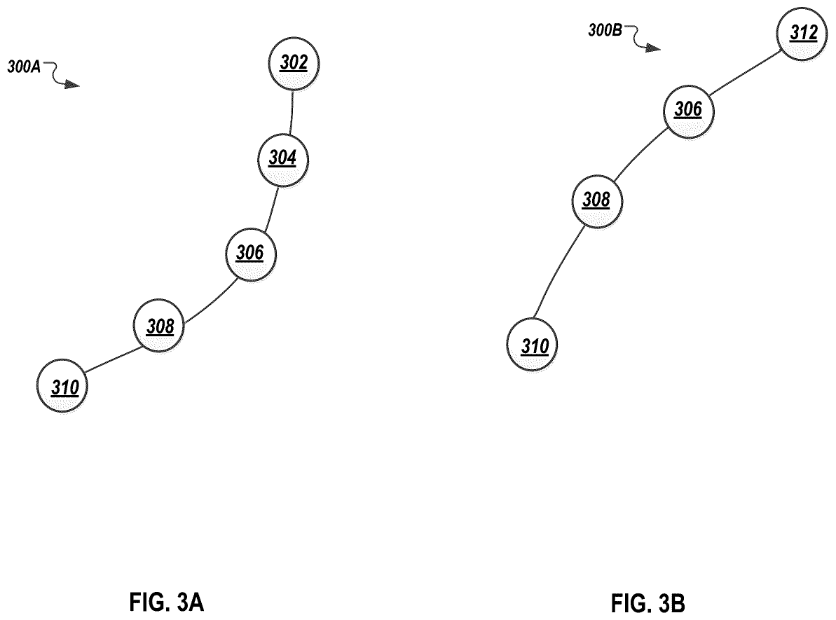

FIG. 3A is a block diagram of an example API composition flow 300A, according to some implementations of the present disclosure. The example API composition flow 300A can include a first sequence of APIs 302, 304, 306, 308, 310. Within the example API composition flow 300A a first API 302 calls a second API 304, which calls a third API 306, that calls a fourth API 308, that calls a fifth API 310. The example API composition flow 300A can be generated, by an API invocation system architecture (e.g., example API invocation system architecture 200, described with reference to FIG. 2), in response to receiving a request from an end user client device (e.g., the end user client device 104, described with reference to FIG. 2).

For example, the request received from an end user client device can inquire about an employee onboarding scenario. Within the context example, the example API composition flow 300A can include a first API 302 configured for onboarding that calls a second API 304 configured for generating a compound employee file, which calls a third API 306 configured for generating an employee profile that calls a fourth API 308 configured for automating communication processes based on pre-defined scenarios, that calls a fifth API 310 that facilitates geocoding.

FIG. 3B is a block diagram of another example API composition flow 300B, according to some implementations of the present disclosure. The example API composition flow 300A can include a second sequence of APIs 312, 306, 308, 310. Within the example API composition flow 300A a first API 312 calls a second API 306, that calls a third API 308, that calls a fourth API 310. The example API composition flow 300B can include a portion of the APIs included in the first sequence of APIs of the example API composition flow 300A and one or more different APIs. For example, the first API 312 of the example API composition flow 300B can include an API that performs the functions of the first and second APIs 302, 304 of the example API composition flow 300A, using optimized computing resources during execution.

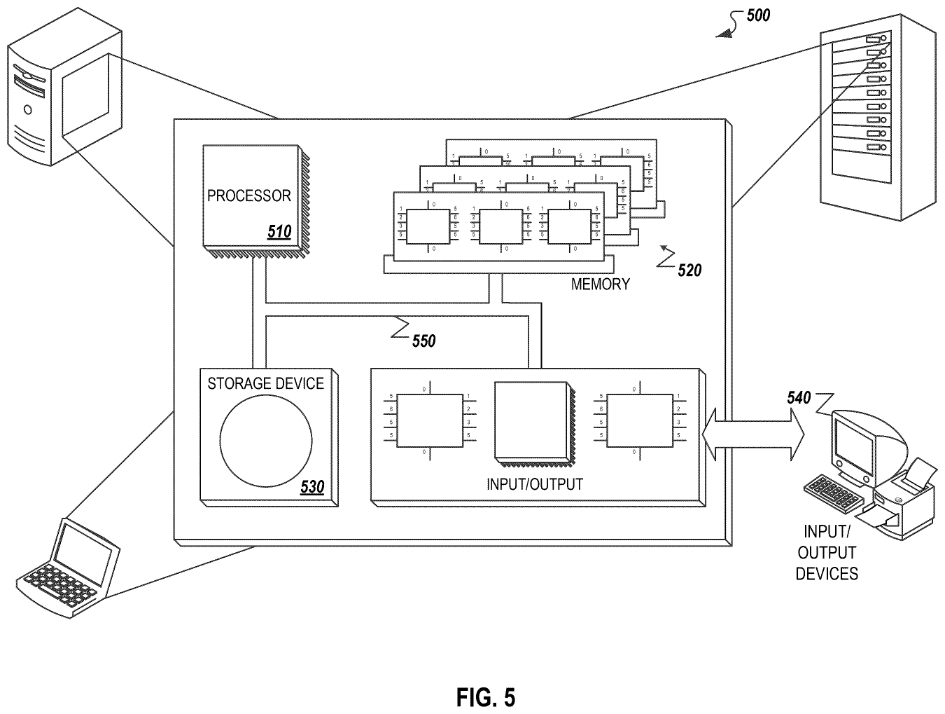

FIG. 4 is a flowchart of an example process 400 for API invocation, according to some implementations of the present disclosure. Example process can be performed by any component of the example system 100, described with reference to FIG. 1 or the example API invocation system architecture 200, described with reference to FIG. 2 or the example computing system 500, described with reference to FIG. 5. For clarity of presentation, the description that follows generally describes example process 400 in the context of FIGS. 1, 2, and 5.

At 402, an API sequence request is received, by an API invocation system from an end user client device. The request can include a prompt to identify a sequence of APIs to perform a task that can include calling multiple APIs.

At 404, API data is obtained from a data collector agent that collected the data from one or more memories of the API providers. The API data includes textual characterization of multiple APIs. The API data includes metadata and API specifications defining API inputs and API outputs. The API data can be received in a format specific to the API provider. API specification and the linked APIs definitions can include machine readable (for example, in JSON/or yet another markup language (YAML) format).

At 406, API embeddings including vector representations are generated from the API data, by embedding the API data. The vector representations of the API data are structured as a semantically searchable format. For example, the API embeddings can be generated using a transformer-based encoder that generates API embeddings from API-based feature sequences. Each API description includes a description of a function. Each function has its own vocabulary. Items from each function are mapped to integer IDs and have distinct embedding representations. To create a combined representation, aligned items can be fused into a single vectorial embedding.

At 408, APIs ranking of relevant APIs is determined you using a similarity function between the vector representations and the request. The similarity function can include a cosine similarity function. The API ranking can be performed by using a RAG engine configured for retrieval of augmented generation of a prompt. The RAG engine is an AI methodology for improving the quality of LLM-generated responses by grounding the engine on external sources of knowledge to supplement the LLM's internal representation of information.

At 410, a query is generated for a completion engine using the ranking of the relevant APIs and the request. The query can be formatted as a natural language (e.g., textual array) describing the problem statement as a request to identify, from the relevant APIs, a set of APIs configured to perform the task.

At 412, a set of APIs selected to perform the task is received from the completion engine. The completion engine includes an artificial intelligence engine, such as a large language engine. The large language engine can be trained to optimize identification of the set of APIs. The trained large language engine can be trained using multiple tasks mapped to API sequence settings. The API sequence settings can define workflow conditions for multiple API types. The APIs included in the set of APIs selected to perform the task can be called in multiple different orders.

At 414, a recommendation including a structure of the sequence of APIs selected from the set of APIs to perform the task is generated. The structure can include a DAG defining API dependencies. The structure can define a calling order of the sequence of APIs that is identified as being an optimized sequenced order of calling the APIs. The sequenced order of calling the APIs can be optimized based on a mapping (e.g., interdependencies and relationships) between the selected APIs and/or based on system resource consumption. In some implementations, simulations of system resource consumptions of similar potential graphs defining different API dependencies can be executed to rank the graphs based on system resource consumptions and select the structure of the API sequence providing a minimal system resource consumption.

At 416, an application invoking the sequence of APIs selected according to the calling order of the sequence of APIs is executed. The execution of the application can include retrieval of one or more APIs in the sequence of APIs from a database. The execution of the application can include generating a new API to be included in the sequence of APIs. The execution of the application can include generating an artifact matching the sequence of APIs. The execution of the application can include code generation for connection to the selected APIs to generate the data flow. The output of the automatically embed API calls in source code can be displayed by a graphical user interface.

The example process 400 for API invocation provide an advantage of contextualizing the LLM with API embeddings during finetuning or inference, which enhances the accuracy of the identification of relevant API calling patterns, facilitating dynamic integration of API sequences in user services. The described example process 400 mitigates the computational demands of processing extensive API data by working with condensed representations of API data, as API embeddings. The described example process 400 integrates a deeper understanding of users' historical patterns and latent intent, enabling LLMs to tailor responses and generate optimized API sequences based on training. The example process 400 employs sophisticated fusion techniques and conducts a comprehensive empirical evaluation across multiple API types and versions to provide a thorough assessment of API relevance and compatibility.

FIG. 5 is a block diagram of an example computing system 500 used to provide computational functionalities associated with described algorithms, methods, functions, processes, flows, and procedures, according to some implementations of the present disclosure. As shown in FIG. 5, the computing system 500 can include a processor 510, a memory 520, a storage device 530, and input/output devices 540. The processor 510, the memory 520, the storage device 530, and the input/output devices 540 can be interconnected using a system bus 550. The processor 510 is capable of processing instructions for execution within the computing system 500, such as the example process 600 described with reference to FIG. 6. Such executed instructions can implement one or more components of, for example, the data integration system 106, described with reference to FIG. 1. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided using the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a LAN, a WAN, the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 540. The user interface can be generated and presented to a user by the computing system 500 (e.g., on a computer screen monitor).

One or more aspects or features of the subject matter described herein can be realized in digital electronic circuitry, integrated circuitry, specially designed ASICs, FPGAS computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. Signals and carrier waves are excluded from “machine-readable medium.” The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving a request to identify a sequence of application programming interfaces (APIs) to perform a task; obtaining, from a data collection engine, API data comprising textual characterization of a plurality of APIs; generating vector representations by embedding the API data of the plurality of APIs, the vector representations comprising a semantically searchable format; determining, by using a retrieval-augmented generation engine, relevant APIs ranking the plurality of APIs according to a similarity between the vector representations and the request; generating a query for a completion engine using the relevant APIs and the request; receiving, from the completion engine, a set of APIs selected to perform the task; generating, a recommendation comprising a structure of the sequence of APIs selected to perform the task, the structure defining a calling order of the sequence of APIs; and executing, using the structure, an application invoking the sequence of APIs selected according to the calling order of the sequence of APIs.

Example 2. The computer-implemented method of claim 1, wherein the completion engine comprises a trained large language engine.

Example 3. The computer-implemented method of any of the preceding examples, wherein the trained large language engine is trained using a plurality of tasks mapped to API sequence settings.

Example 4. The computer-implemented method of any of the preceding examples, wherein the API sequence settings define workflow conditions for a plurality of API types.

Example 5. The computer-implemented method of any of the preceding examples, wherein the API data comprises metadata and specifications.

Example 6. The computer-implemented method of any of the preceding examples, wherein executing the application comprises retrieving one or more APIs in the sequence of APIs from a database.

Example 7. The computer-implemented method of any of the preceding examples, wherein executing the application comprises generating a new API to be included in the sequence of APIs.

Example 8. The computer-implemented method of any of the preceding examples, wherein executing the application comprises generating an artifact matching the sequence of APIs.

Example 9. A computer-implemented system comprising: an embedding engine that receives, from a data collection engine, application programming interface (API) data of a plurality of APIs and generates vector representations by embedding the API data, wherein the API data comprises textual characterization of a plurality of APIs and the vector representations comprise a semantically searchable format; a ranking engine that receives, from the embedding engine, the vector representations and generates a query using relevant APIs and a received request to identify a sequence of application programming interfaces (APIs) to perform a task, wherein the relevant APIs are determined by ranking the plurality of APIs according to a similarity between the vector representations and a request; a completion engine that determines a set of APIs selected to perform the task by using the query generated by the ranking engine; and a graph recommendation engine that processes the set of APIs to generate a structure recommendation.

Example 10. The computer-implemented system of example 9, wherein the prediction model comprises a trained large language model.

Example 11. The computer-implemented system of any of the preceding examples, wherein the trained large language model is trained using a plurality of tasks mapped to API sequence settings.

Example 12. The computer-implemented system of any of the preceding examples, wherein the API sequence settings define workflow conditions for a plurality of API types.

Example 13. The computer-implemented system of any of the preceding examples, wherein the API data comprises metadata and specifications.

Example 14. The computer-implemented system of any of the preceding examples, wherein the ranking engine comprises a retrieval-augmented generation engine.

Example 15. The computer-implemented system of any of the preceding examples, wherein the embedding engine executes an embedding function to generate the vector representations of the API descriptions.

Example 16. The computer-implemented system of any of the preceding examples, wherein the graph recommendation engine comprises a directed acyclic graph recommendation engine.

Example 17. A non-transitory computer-readable media encoded with a computer program, the computer program comprising instructions that when executed by one or more computers cause the one or more computers to perform operations comprising: receiving a request to identify a sequence of application programming interfaces (APIs) to perform a task; obtaining, from a data collection engine, API data comprising textual characterization of a plurality of APIs; generating vector representations by embedding the API data of the plurality of APIs, the vector representations comprising a semantically searchable format; determining, by using a retrieval-augmented generation engine, relevant APIs ranking the plurality of APIs according to a similarity between the vector representations and the request; generating a query for a completion engine using the relevant APIs and the request; receiving, from the completion engine, a set of APIs selected to perform the task; generating, a recommendation comprising a structure of the sequence of APIs selected to perform the task, the structure defining a calling order of the sequence of APIs; and executing, using the structure, an application invoking the sequence of APIs selected according to the calling order of the sequence of APIs.

Example 18. The non-transitory computer-readable media of example 17, wherein the completion engine comprises a trained large language engine, wherein the trained large language engine is trained using a plurality of tasks mapped to API sequence settings, wherein the API sequence settings define workflow conditions for a plurality of API types.

Example 19. The non-transitory computer-readable media of any of the preceding examples, wherein the API data comprises metadata and specifications.

Example 20. The non-transitory computer-readable media of any of the preceding examples, wherein executing the application comprises retrieving one or more APIs in the sequence of APIs from a database, wherein executing the application comprises generating a new API to be included in the sequence of APIs.

What is claimed is:

1. A computer-implemented method comprising:
receiving a request to identify a sequence of application programming interfaces (APIs) to perform a task;
obtaining, from a data collection engine, API data comprising textual characterization of a plurality of APIs;
generating vector representations by embedding the API data of the plurality of APIs, the vector representations comprising a semantically searchable format;
determining, by using a retrieval-augmented generation engine, relevant APIs ranking the plurality of APIs according to a similarity between the vector representations and the request;
generating a query for a completion engine using the relevant APIs and the request;
receiving, from the completion engine, a set of APIs selected to perform the task;
generating, a recommendation comprising a structure of the sequence of APIs selected to perform the task, the structure defining a calling order of the sequence of APIs; and
executing, using the structure, an application invoking the sequence of APIs selected according to the calling order of the sequence of APIs.

2. The computer-implemented method of claim 1, wherein the completion engine comprises a trained large language engine.

3. The computer-implemented method of claim 2, wherein the trained large language engine is trained using a plurality of tasks mapped to API sequence settings.

4. The computer-implemented method of claim 3, wherein the API sequence settings define workflow conditions for a plurality of API types.

5. The computer-implemented method of claim 1, wherein the API data comprises metadata and specifications.

6. The computer-implemented method of claim 1, wherein executing the application comprises retrieving one or more APIs in the sequence of APIs from a database.

7. The computer-implemented method of claim 6, wherein executing the application comprises generating a new API to be included in the sequence of APIs.

8. The computer-implemented method of claim 1, wherein executing the application comprises generating an artifact matching the sequence of APIs.

9. A computer-implemented system comprising:
an embedding engine that receives, from a data collection engine, application programming interface (API) data of a plurality of APIs and generates vector representations by embedding the API data, wherein the API data comprises textual characterization of a plurality of APIs and the vector representations comprise a semantically searchable format;
a ranking engine that receives, from the embedding engine, the vector representations and generates a query using relevant APIs and a received request to identify a sequence of application programming interfaces (APIs) to perform a task, wherein the relevant APIs are determined by ranking the plurality of APIs according to a similarity between the vector representations and a request;
a completion engine that determines a set of APIs selected to perform the task by using the query generated by the ranking engine; and
a graph recommendation engine that processes the set of APIs to generate a structure recommendation.

10. The computer-implemented system of claim 9, wherein the prediction model comprises a trained large language model.

11. The computer-implemented system of claim 10, wherein the trained large language model is trained using a plurality of tasks mapped to API sequence settings.

12. The computer-implemented system of claim 11, wherein the API sequence settings define workflow conditions for a plurality of API types.

13. The computer-implemented system of claim 12, wherein the API data comprises metadata and specifications.

14. The computer-implemented system of claim 9, wherein the ranking engine comprises a retrieval-augmented generation engine.

15. The computer-implemented system of claim 14, wherein the embedding engine executes an embedding function to generate the vector representations of the API descriptions.

16. The computer-implemented system of claim 9, wherein the graph recommendation engine comprises a directed acyclic graph recommendation engine.

17. A non-transitory computer-readable media encoded with a computer program, the computer program comprising instructions that when executed by one or more computers cause the one or more computers to perform operations comprising:
receiving a request to identify a sequence of application programming interfaces (APIs) to perform a task;
obtaining, from a data collection engine, API data comprising textual characterization of a plurality of APIs;
generating vector representations by embedding the API data of the plurality of APIs, the vector representations comprising a semantically searchable format;
determining, by using a retrieval-augmented generation engine, relevant APIs ranking the plurality of APIs according to a similarity between the vector representations and the request;
generating a query for a completion engine using the relevant APIs and the request;
receiving, from the completion engine, a set of APIs selected to perform the task;
generating, a recommendation comprising a structure of the sequence of APIs selected to perform the task, the structure defining a calling order of the sequence of APIs; and
executing, using the structure, an application invoking the sequence of APIs selected according to the calling order of the sequence of APIs.

18. The non-transitory computer-readable media of claim 17, wherein the completion engine comprises a trained large language engine, wherein the trained large language engine is trained using a plurality of tasks mapped to API sequence settings, wherein the API sequence settings define workflow conditions for a plurality of API types.

19. The non-transitory computer-readable media of claim 17, wherein the API data comprises metadata and specifications.

20. The non-transitory computer-readable media of claim 17, wherein executing the application comprises retrieving one or more APIs in the sequence of APIs from a database, wherein executing the application comprises generating a new API to be included in the sequence of APIs.
